(19) United States
(12) Patent Application Publication
(10) Pub. No.: US 2007/0283896 A1
(43) Pub. Date: Dec. 13, 2007

(54) LITTER CONTAINMENT AND DISPOSAL APPARATUS

(76) Inventor: Ernest Walker, Staten Island, NY (US)

Correspondence Address: MEREDITH & KEYHANI, PLLC, 330 MADISON AVE., 6TH FLOOR, NEW YORK, NY, 10017, US

(21) Appl. No.: 11/691,534

(22) Filed: Mar. 27, 2007

Related U.S. Application Data
(60) Provisional application No. 60/787,140, filed on Mar. 29, 2006.

(51) Int. Cl. A01K 29/00; A01K 23/00

(52) U.S. Cl. 119/166

(57) ABSTRACT

A litter containment and disposal apparatus, the apparatus comprising: an open top rectangular portion having a bottom with at least one cutout opening therein and at least three sides; a base portion in communication with the bottom having a drawer, wherein the drawer is directly below and slightly larger than the at least one cutout opening; and an absorbent bag container, wherein the absorbent bag container is smaller than the drawer and adapted to fit inside the drawer and the absorbent bag container contains an absorbent material

This application claims priority to provisional patent application No. 60/787,140 entitled “Kitty's Kastle” filed Mar. 29, 2006.

The present invention relates to animal litter apparatus, and in particular to an improved cat litter box. Cats instinctively bury their waste, which makes them easy to litter train. Pet owners, though, dread cleaning the litter box which is may have a strong odor and be unsanitary. The problem is compounded when a pet owner own multiple cats. Consumers that would like to have litter-trained pets are often deterred by the thought of a potentially smelly litter box. The present invention absorbs, neutralizes and deodorizes the smells associated with litter systems and enables pet owners to quickly and easily clean the litter area.

Another problem with the prior art is the removal of pellet type kitty litter. This is sloppy and may spill. The present invention provides a contained bag and/or strip that is filled with an absorbent material, so it is self contained and the bag may be removed.

Accordingly, the present invention provides an easy to clean litter box with removable contained absorbent bags.

### SUMMARY OF THE INVENTION

The present invention relates generally to an apparatus for containing and easily disposing of animal litter.

According to one embodiment, a litter containment and disposal apparatus is provided, the apparatus comprising: an open top rectangular portion having a bottom with at least one cutout opening therein and at least three sides; a base portion in communication with the bottom having a drawer, wherein the drawer is directly below and slightly larger than the at least one cutout opening; and an absorbent bag container, wherein the absorbent bag container is smaller than the drawer and adapted to fit inside the drawer and the absorbent bag container contains an absorbent material.

According to another embodiment, a litter containment and disposal apparatus, the apparatus comprising: an open top rectangular portion having a bottom with at least one cutout opening therein and at least three sides; a drawer in communication with a portion of the bottom, wherein the drawer is directly below and slightly larger than the at least one cutout opening; and an absorbent bag container, wherein the absorbent bag container is smaller than the drawer and adapted to fit inside the drawer.

These and other features, aspects and advantages of the present invention will become better understood with reference to the following description and claims.

### BRIEF DESCRIPTION OF THE DRAWINGS

FIG. 1 depicts the present invention;

FIG. 2 depicts the present invention;

FIG. 3 depicts the present invention;

FIG. 4 depicts the present invention;

FIG. 5 depicts the present invention;

FIG. 6 depicts the present invention;

FIG. 7 depicts the present invention;

FIG. 8 depicts the present invention;

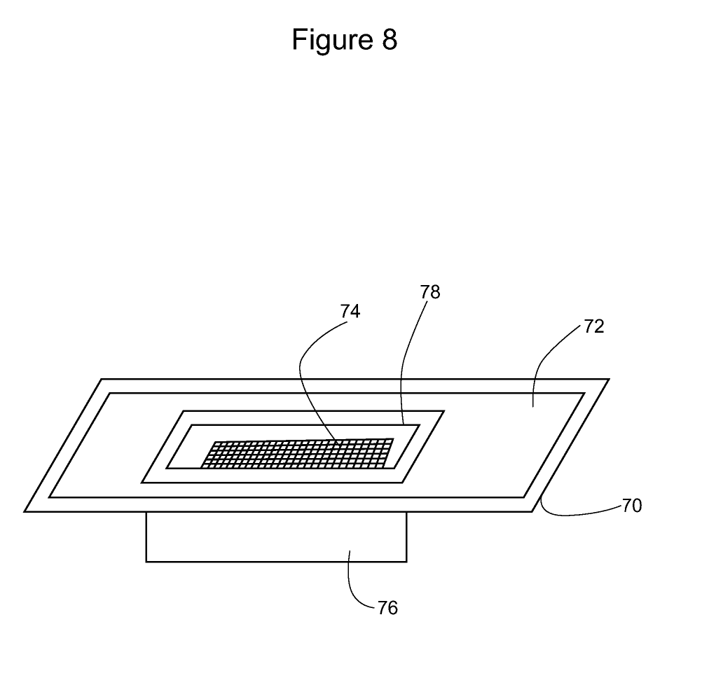

FIG. 9 depicts the present invention;

FIG. 10 depicts the present invention; and

FIG. 11 depicts the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention was redeveloped as an easier and more effective apparatus to clean pet litter from a litter box. A sliding tray may act as a drawer with waste contained in a bag that is contained in the drawer or tray. Solid waste may remain on the top of kitty litter and liquid waste may travel through the kitty litter to be trapped in an absorbent bag in the tray or drawer. The absorbent bag may neutralize and deodorize the waste.

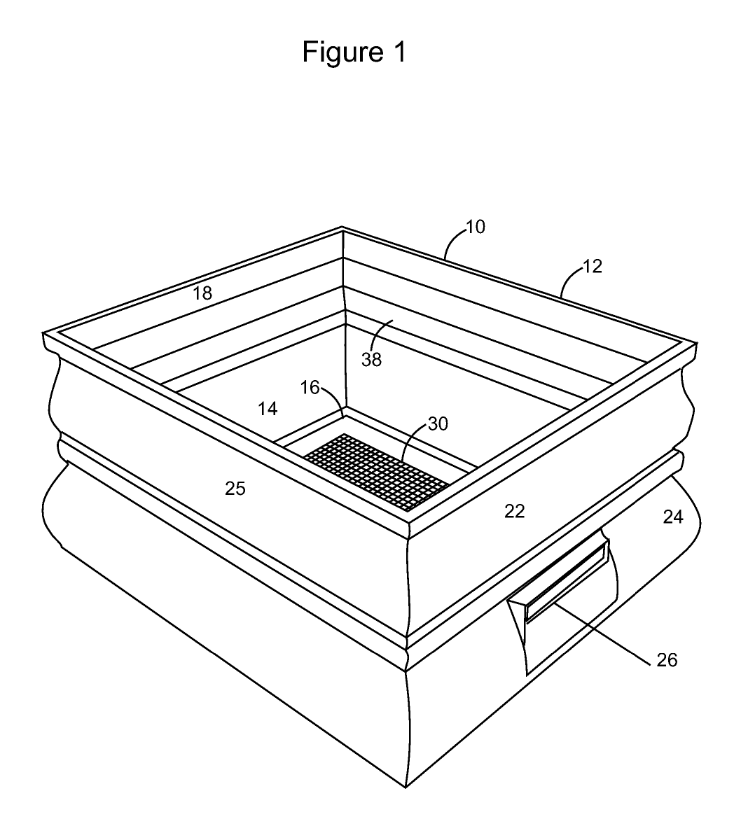

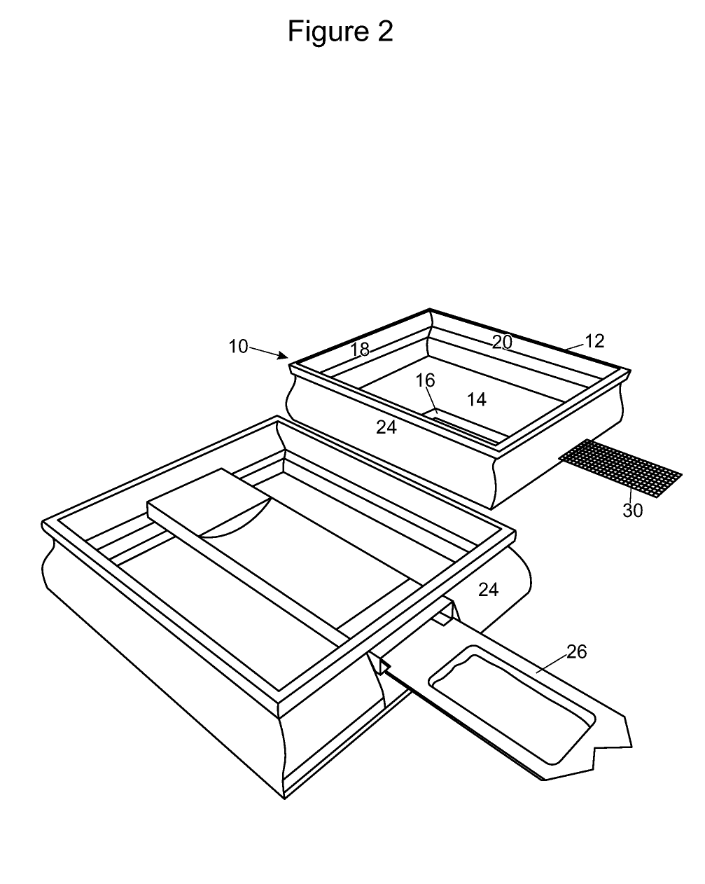

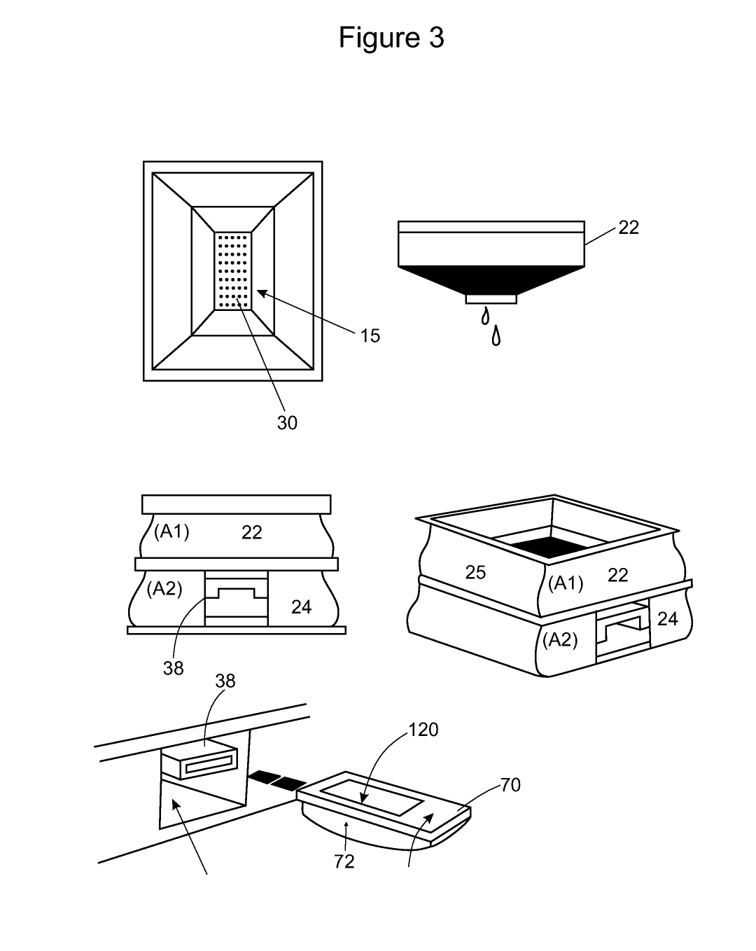

A litter containment and disposal apparatus, as shown in FIGS. 1-4, the apparatus (10) comprising: an open top rectangular portion (12) having a bottom (14) with at least one cutout opening (16) therein and at least three sides (18, 20, 22, 25); a base portion (24) in communication with the bottom (14) having a drawer (26), wherein the drawer (26) is directly below and slightly larger than the at least one cutout opening (16); and an absorbent bag container (28), wherein the absorbent bag container (28) is smaller than the drawer (26) and adapted to fit inside the drawer and the absorbent bag container contains an absorbent material (28). There may be a screen (30), wherein the screen (30) is in communication with and covers the cutout opening (16). The screen (30) may be above or below the cutout opening (16). The bottom (14) may be sloped (15) or concaved towards the cutout opening. There may also be at least one liquid channel (38) for diverting liquids to the at least one cutout opening. The absorbent material may be cellulosic airlaid webs of comminuted fibers, wood cellulose fibers, cellulose-superabsorbent mixtures or composites, hydroentangled webs comprising cellulosic fibers, composites of synthetic fibers and papermaking fibers such as coform, rayon, lyocell, solvent-spun hydrophilic fibers, cellulosic foams including regenerated cellulose foams; hydrophilic, flexible foams, absorbent foams, fiber-foam composites, absorbent nonwoven webs, cotton, wool or keratin fibers, peat moss, silica gel, super absorbent polymer, hydrogels, sodium polyacrylate, and other absorbent vegetable matter. It is important, though, that the absorbent material be contained in the absorbent bag container (28) to provide easy disposal. As shown in FIG. 3, there may also be an open rectangular cardboard portion (70) in communication with an absorbent bag material (76), wherein the opening (78) in the open rectangular cardboard portion is aligned under the cutout opening (16) in the bottom (14) of the apparatus (10). The drawer may be made of cardboard (or thin plastic similar to that plastic cups are made of) to provide a disposable drawer. In the alternative, the drawer may be made of metal or any other solid material and the absorbent bag container may be disposable. There may also be an adhesive material (72) in communication with the top of the rectangular cardboard portion (70). The adhesive material acts to seal the top of the absorbent bag to the apparatus to provide a leak free seal and disposal when thrown away. The drawer may be comprised of a receiving portion (38) with opposing L portions and the top flat portion (70) fits into the receiving portion (38) to allow the absorbent bag container (72) to hang below the cutout opening (16). There may also be a channel (71) and a receiving bottom (73). The receiving bottom (73) may also be an inclined drip pan which acts to channel liquid to the absorbent bag.

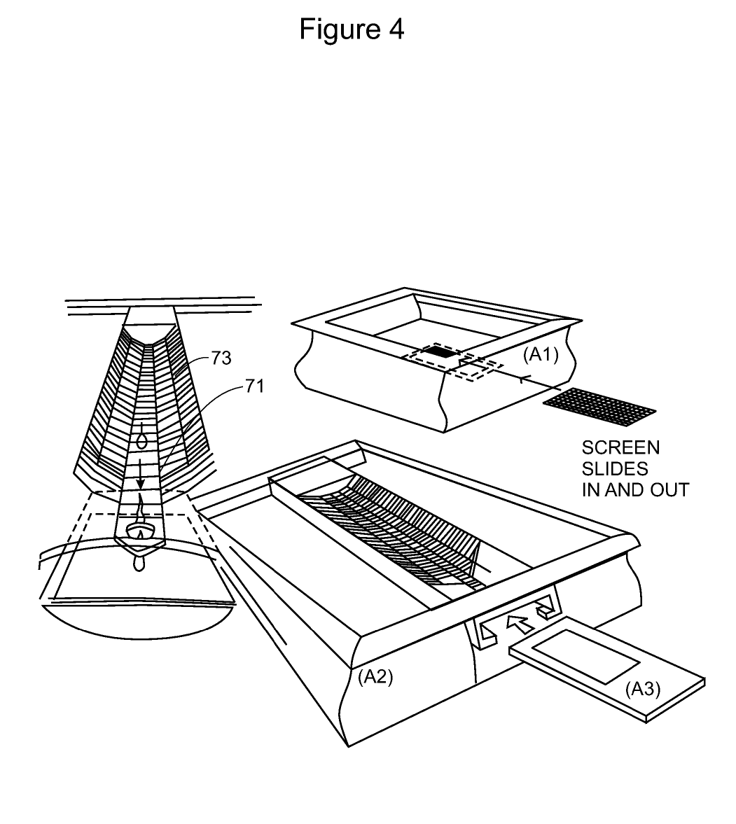

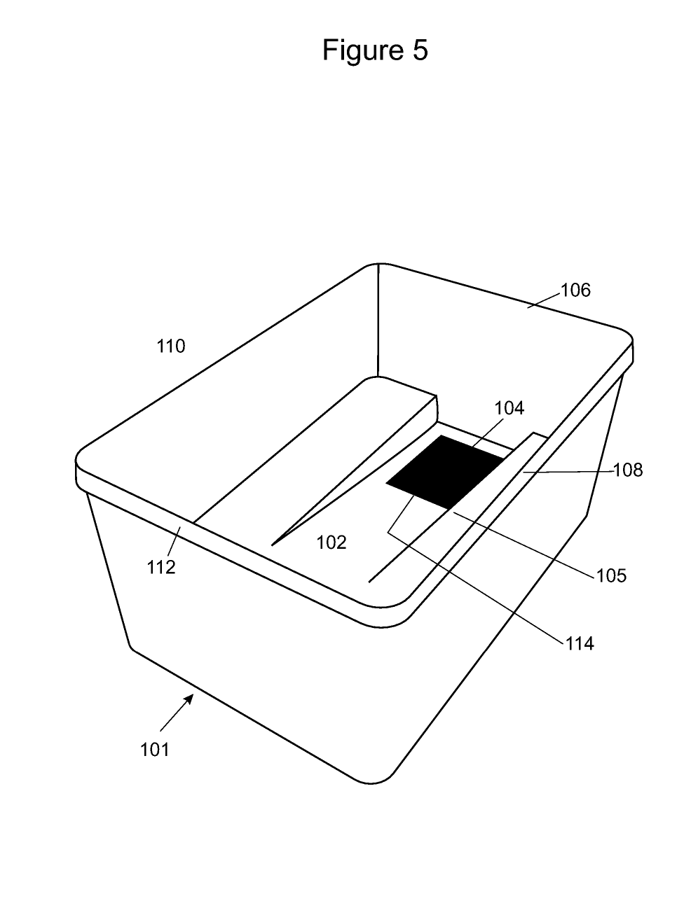

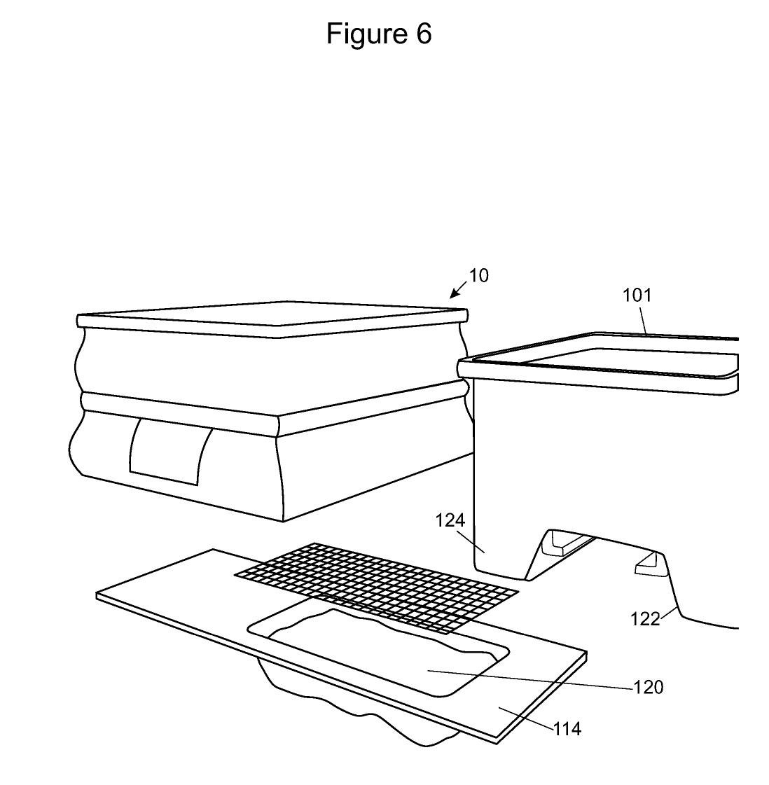

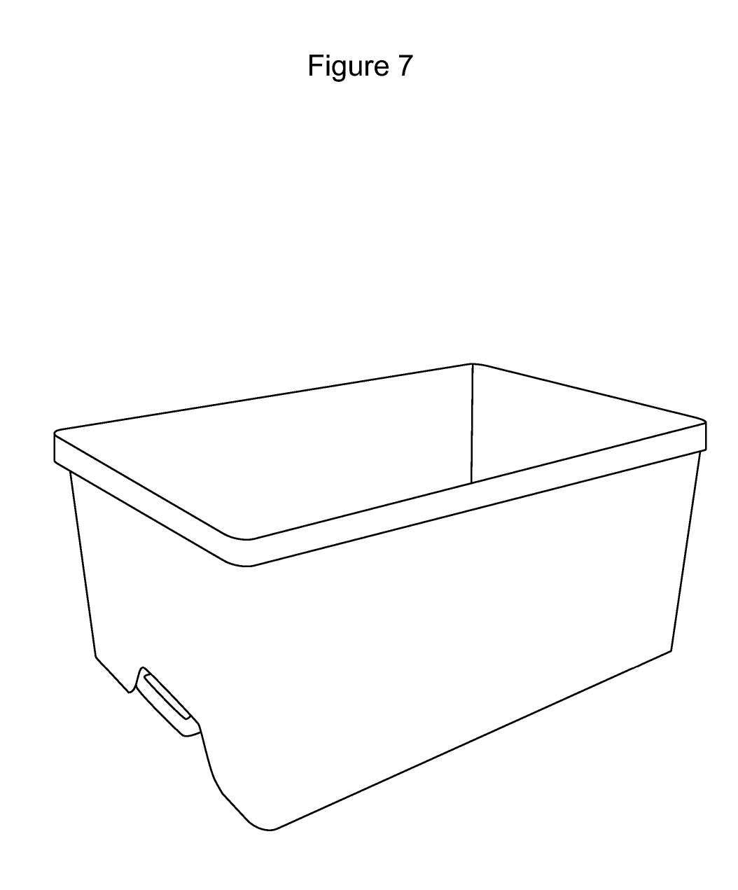

Turning to FIGS. 5-7, a litter containment and disposal apparatus is provided, the apparatus comprising: an open top rectangular portion (100) having a bottom (102) with at least one cutout opening (104) therein and at least three sides (106, 108, 110, 112); a drawer (114) in communication with a portion of the bottom (102), wherein the drawer (114) is directly below and slightly larger than the at least one cutout opening (104); and an absorbent bag container (120), wherein the absorbent bag container is smaller than the drawer (114) and adapted to fit inside the drawer (114). As shown in FIG. 4, there may be a separate top rectangular portion (12) and a base portion (24) as in apparatus (10) or the unit may be a single unit (101) having an open top rectangular portion (100) and drawer (114). In this situation, there may be legs (122, 124). It is also possible, that there just may be a drawer in a middle portion of the open top rectangular portion (100). In such a situation kitty litter may be used to fill around the drawer. There may be a screen (104), wherein the screen (104) is in communication with and covers the cutout opening (105). The bottom (102) may be sloped towards the cutout opening (105). There may also be at least one channel (114) in the bottom, wherein the at least one channel directs liquids to the cutout opening.

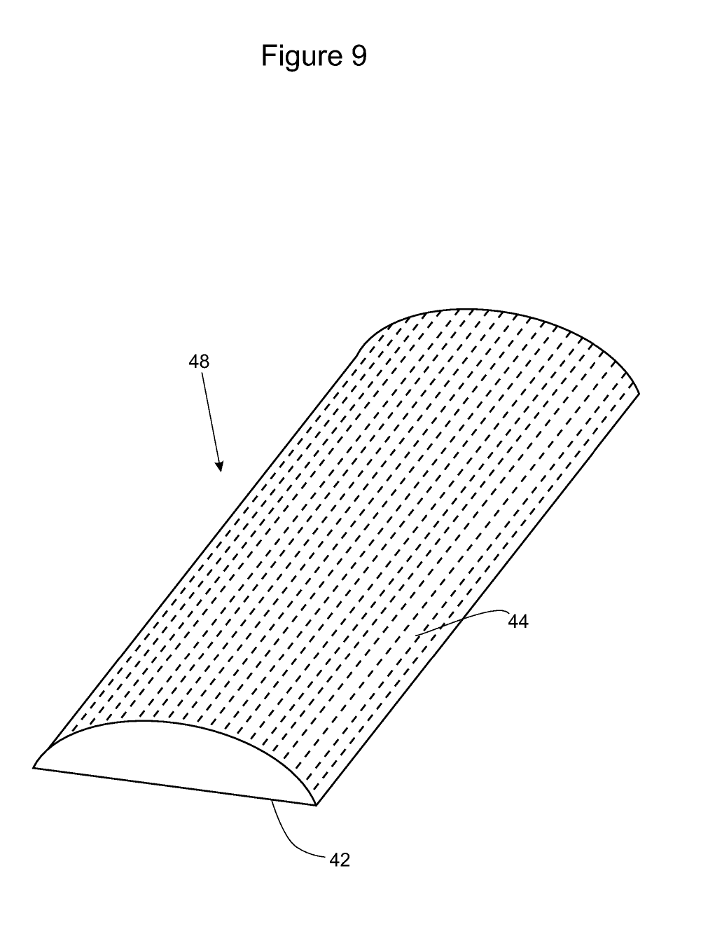

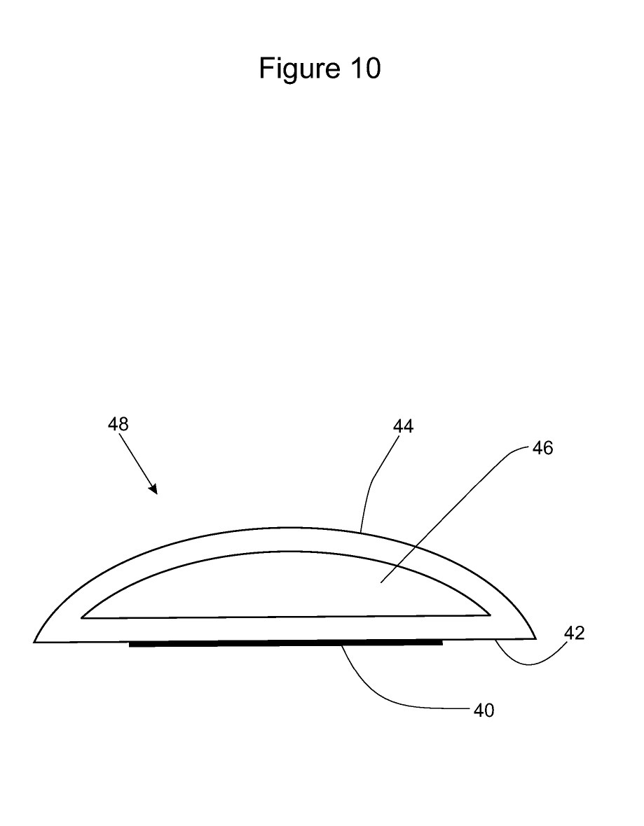

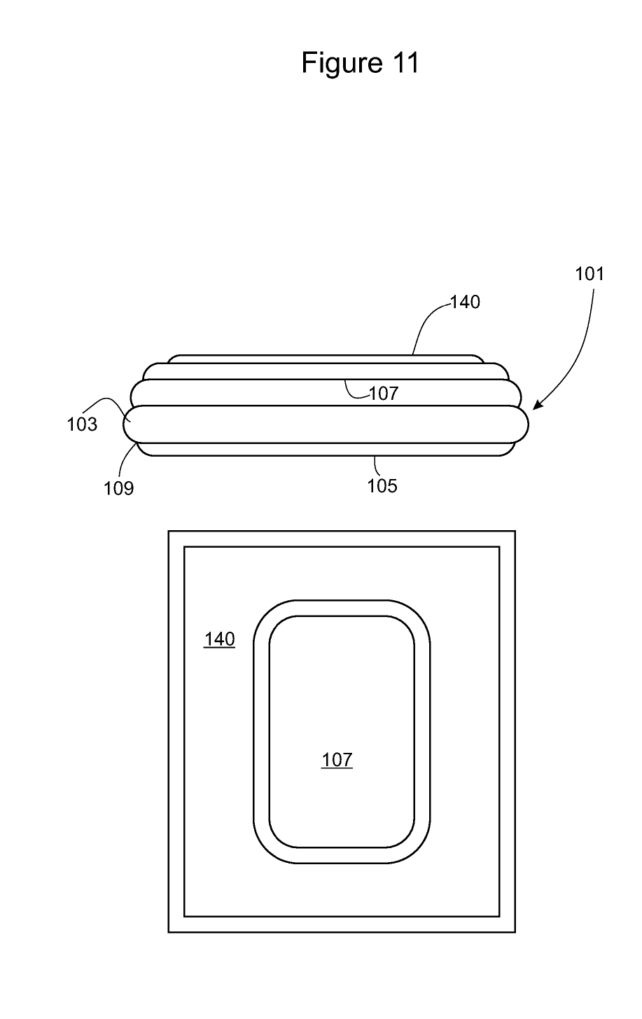

As shown in FIG. 9-11, the absorbent bag container (48) may an elongated strip having: a liquid impervious backsheet (42) with adhesive material (40); a liquid pervious topsheet (44) attached to the backsheet (42); an absorbent core (46) disposed between the topsheet (44) and the backsheet (42). The apparatus as in the present invention may be adapted to accept feminine pads or incontinence pads as are currently on the market. The absorbent bag container has a liquid pervious cover and an absorbent core disposed contained inside the liquid pervious cover. This is to say it may be round, oval or bag shaped. The liquid pervious cover may be a single piece sewn or affixed together to form a round oval or bag shape. The absorbent bag container (101) may further have a side wall (103), wherein the side wall (103) is liquid impervious and is between the liquid impervious backsheet (105) and may have a liquid pervious topsheet (107) and has at least one fold (109) to allow the absorbent bag (101) to expand. The absorbent bag container (101) may be round, oval, bag shaped, rectangular or any other desired shape. The side wall (103) is made of liquid impervious material. There may also be an adhesive material (140) to provide secure attachment. There may be the liquid pervious topsheet (106). However, it also envisioned that the absorbent material may take many forms and not require a liquid pervious topsheet (106).

As used herein, a material is said to be “absorbent” if it can retain an amount of water equal to at least 100% of its dry weight as measured by the test for Intrinsic Absorbent Capacity given below (i.e., the material has an Intrinsic Absorbent Capacity of at about 1 or greater). Desirably, the absorbent materials used in the absorbent members of the present invention have an Intrinsic Absorbent Capacity of about 2 or greater, more specifically about 4 or greater, more specifically still about 7 or greater, and more specifically still about 10 or greater, with exemplary ranges of from about 3 to about 30 or from about 4 to about 25 or from about 12 to about 40.

The absorbent material may be cellulosic airlaid webs of comminuted fibers (commonly termed “airfelt”); wood cellulose fibers; cellulose-superabsorbent mixtures or composites; hydroentangled webs comprising cellulosic fibers; composites of synthetic fibers and papermaking fibers such as coform, as disclosed in U.S. Pat. No. 4,879,170, issued Nov. 7, 1989 to Radwanski et al.; rayon; lyocell or other solvent-spun hydrophilic fibers, such as those disclosed in U.S. Pat. No. 5,725,821, issued Mar. 10, 1998 to Gannon et al.; cellulosic foams including regenerated cellulose foams; hydrophilic, flexible foams or absorbent foams produced from high internal phase emulsions (HIPE), such as the foams disclosed in U.S. Pat. No. 5,692,939, issued Dec. 2, 1997 to DesMarais; fiber-foam composites; absorbent nonwoven webs; cotton; wool or keratin fibers; peat moss and other absorbent vegetable matter, and any other known absorbent material. The liquid impervious backsheet may be made with a moisture-proof plastic such as polypropylene or polyethylene

It should be understood that the foregoing relates to preferred embodiments of the invention and that modifications may be made without departing from the spirit and scope of the invention as set forth in the following claims.

1. A litter containment and disposal apparatus, said apparatus comprising:
an open top rectangular portion having a bottom with at least one cutout opening therein and at least three sides;
a base portion in communication with said bottom having a drawer, wherein said drawer is directly below and slightly larger than said at least one cutout opening; and
an absorbent bag container, wherein said absorbent bag container is smaller than said drawer and adapted to fit inside said drawer and said absorbent bag container contains an absorbent material.

2. A litter containment and disposal apparatus as in claim 1, further comprising a screen, wherein said screen is in communication with and covers said cutout opening.

3. A litter containment and disposal apparatus as in claim 1, wherein said absorbent bag container is an elongated strip comprising:
a liquid impervious backsheet with adhesive material;
a liquid pervious topsheet attached to said backsheet;
an absorbent core disposed between said topsheet and said backsheet.

4. A litter containment and disposal apparatus as in claim 3, said absorbent bag container further comprising a side wall, wherein said side wall is between said liquid impervious backsheet and said a liquid pervious topsheet and has at least one fold to allow said absorbent bag to expand.

5. A litter containment and disposal apparatus as in claim 1, wherein said bottom with a cutout opening therein is sloped towards said cutout opening.

6. A litter containment and disposal apparatus as in claim 1, further comprising at least one liquid channel for diverting liquids to said at least one absorbent bag container.

7. A litter containment and disposal apparatus as in claim 1, wherein said absorbent material is selected from the group consisting of cellulosic airlaid webs of comminuted fibers, wood cellulose fibers, cellulose-superabsorbent mixtures or composites, hydroentangled webs comprising cellulosic fibers, composites of synthetic fibers and papermaking fibers such as coform, rayon, lyocell, solvent-spun hydrophilic fibers, cellulosic foams including regenerated cellulose foams; hydrophilic, flexible foams, absorbent foams, fiber-foam composites, absorbent nonwoven webs, cotton, wool or keratin fibers, peat moss, silica gel, super absorbent polymer, hydrogels, sodium polyacrylate, and other absorbent vegetable matter.

8. A litter containment and disposal apparatus as in claim 1, further comprising an open rectangular cardboard portion in communication with said absorbent bag material, wherein said open rectangular cardboard portion has an opening that aligned under said cutout opening in said bottom of said apparatus.

9. A litter containment and disposal apparatus as in claim 1, further comprising an adhesive material in communication with said top rectangular cardboard portion;

10. A litter containment and disposal apparatus as in claim 1, wherein said absorbent bag container has a liquid pervious cover and an absorbent core disposed contained inside said liquid pervious cover.

11. A litter containment and disposal apparatus as in claim 1, further comprising at least one channel in said bottom, wherein said at least one channel directs liquids to said absorbent bag container.

12. A litter containment and disposal apparatus, said apparatus comprising:
an open top rectangular portion having a bottom with at least one cutout opening therein and at least three sides;
a drawer in communication with a portion of said bottom, wherein said drawer is directly below and slightly larger than said at least one cutout opening; and
an absorbent bag container, wherein said absorbent bag container is smaller than said drawer and adapted to fit inside said drawer.

13. A litter containment and disposal apparatus as in claim 11, further comprising a screen, wherein said screen is in communication with and covers said cutout opening.

14. A litter containment and disposal apparatus as in claim 11, further comprising a bag containing absorbent material, wherein said bag is slightly smaller than said drawer and adapted to fit in said drawer.

15. A litter containment and disposal apparatus as in claim 11, wherein said bag is an elongated strip comprising:
an liquid impervious backsheet with adhesive material;
a liquid pervious topsheet attached to said backsheet;
an absorbent core disposed between said topsheet and said backsheet.

16. A litter containment and disposal apparatus as in claim 15, said absorbent bag container further comprising a side wall, wherein said side wall is between said liquid impervious backsheet and said a liquid pervious topsheet and has at least one fold to allow said absorbent bag to expand.

17. A litter containment and disposal apparatus as in claim 12, wherein said bottom with a cutout opening therein is sloped towards said cutout opening.

18. A litter containment and disposal apparatus as in claim 12, wherein said absorbent material is selected from the group consisting of cellulosic airlaid webs of comminuted fibers, wood cellulose fibers, cellulose-superabsorbent mixtures or composites, hydroentangled webs comprising cellulosic fibers, composites of synthetic fibers and papermaking fibers such as coform, rayon, lyocell, solvent-spun hydrophilic fibers, cellulosic foams including regenerated cellulose foams; hydrophilic, flexible foams, absorbent foams, fiber-foam composites, absorbent nonwoven webs, cotton, wool or keratin fibers, peat moss, silica gel, super absorbent polymer, hydrogels, sodium polyacrylate, and other absorbent vegetable matter.

19. A litter containment and disposal apparatus as in claim 12, further comprising an open rectangular cardboard portion in communication with said absorbent bag material, wherein said open rectangular cardboard portion has an opening that aligned under said cutout opening in said bottom of said apparatus.

20. A litter containment and disposal apparatus as in claim 12, further comprising an adhesive material in communication with said top rectangular cardboard portion;

21. A litter containment and disposal apparatus as in claim 12, wherein said absorbent bag container has a liquid pervious cover and an absorbent core disposed contained inside said liquid pervious cover.

22. A litter containment and disposal apparatus as in claim 12, further comprising at least one channel in said bottom, wherein said at least one channel directs liquids to said absorbent bag container.
